(19) United States
(12) Patent Application Publication
(10) Pub. No.: US 2026/0027799 A1
(43) Pub. Date: Jan. 29, 2026

(54) METHOD FOR PRODUCING A CORRUGATED CARDBOARD WEB BY MEANS OF A CORRUGATOR, CORRUGATOR, AND COMPUTER PROGRAMME PRODUCT

(71) Applicant: BHS Corrugated Maschinen- und Anlagenbau GmbH, Weiherhammer (DE)

(72) Inventor: Thomas Meenken, Floß (DE)

(21) Appl. No.: 18/998,448

(22) PCT Filed: Sep. 12, 2023
(86) PCT No.: PCT/EP2023/074987

§ 371 Date: Jan. 24, 2025

(30) Foreign Application Priority Data
Sep. 14, 2022 (DE) 10 2022 209 637.1

(51) Int. Cl. B31F 1/20; G05B 19/418

(52) U.S. Cl. CPC B31F 1/20; G05B 19/41835; G05B 2219/39406

(57) ABSTRACT

The invention relates to a method for producing a corrugated cardboard web (4) by means of a corrugator (2), a plurality of paper rolls (10, 12) being provided, each having a paper web made of paper, the paper rolls (10, 12) each being characterised by a number of paper parameters (16) which have individual values for each of the paper rolls (10, 12) so that each of the paper rolls (10, 12) is individually characterised on the basis of their values for the paper parameters (16), an assignment rule (18) being provided which links the paper parameters (16) of two paper rolls (10, 12) with a quality parameter (20) which results from combining said two paper rolls (10, 12) for producing the corrugated cardboard web (4), a first paper roll (10) and a second paper roll (12) being selected from the paper rolls (10, 12) with the aid of the assignment rule (18) in such a way that the quality parameter (20) is optimised, the corrugated cardboard web (4) being produced by feeding the first and second paper rolls (10, 12) to the corrugator (2) which then connects the paper webs of said first and second paper rolls (10, 12) to one another. The invention also relates to a corrugator (2) and to a computer programme product.

The invention relates to a method for producing a corrugated cardboard web by means of a corrugator as well as to a corresponding corrugator and to a computer program product.

A corrugator is used to produce a corrugated cardboard web. The corrugator is fed with several paper webs in the form of paper rolls. The paper rolls are unwound using a respective unwinder of the corrugator, and the paper webs thus produced are joined together to form a corrugated cardboard web using several processing units. Here, for example, one of the paper webs (the so-called fluting) is corrugated with a corrugating roll and then glued to two non-corrugated paper webs (for example outer layers). Multi-layer corrugated cardboard webs with more than one corrugated paper web are also possible. The finished corrugated cardboard web is then optionally finished using the corrugator, i.e., cut into individual pieces and, if necessary, slit and/or grooved.

The quality of the corrugated cardboard web produced depends on the one hand upon the choice of appropriate values for the operating parameters of the corrugator in operation (i.e., during the production of the corrugated cardboard web), but on the other hand also upon the properties of the paper webs from which the corrugated cardboard web is produced. The operating parameters are set, for example, during operation of the corrugator and manually by an operator or automatically depending upon measurements using sensors directly in front of a respective processing unit (inline measurement). In this way, it is possible to react to changing environmental conditions as well as to varying properties of the paper webs. For example, temperature and moisture controls are conceivable for adjusting the temperature and moisture of a particular paper web as part of a control system for the corrugator, in order to influence the processing result of a particular processing unit as optimally as possible immediately before this processing unit.

Despite efforts to make the paper webs as similar as possible, the properties of different paper webs can sometimes vary considerably, so that paper webs with different properties are regularly joined together. Depending on which properties are different and the extent to which the paper webs differ, the quality of the corrugated cardboard web may be reduced or waste may even be directly produced. For example, distortion of the corrugated cardboard web (also called “warp”) may regularly be attributed to varying properties of the paper webs joined together. It is also possible that, depending on the moisture content of the paper webs, these are sometimes not optimally glued together. In principle, it is conceivable to use open-loop control to control the corrugator in such a way, i.e. to adjust its operating parameters in such a way, that varying properties of the paper webs are compensated for as much as possible.

Reference is made to U.S. Pat. Nos. 11,162,226 B2, 10,095,206 B2, EP 3 392 649 B1, EP 3 369 564 B1, EP 2 572 038 B1, EP 2 406 616 B1, EP 2 391 505 B1, EP 1 902 833 A1, EP 0 936 059 A2, DE 10 2017 219 064 A1, DE 10 2015 206 650 A1, CN 107 458 032 A, CN 107 631 684 A, CN 112 644 092 B, CN 207 105 756 U and CN 210 553 357 U.

Against this background, it is an object of the invention to improve the production of a corrugated cardboard web. For this purpose, a suitable method for producing a corrugated cardboard web, a corrugator and a computer program product are to be specified.

The object is achieved according to the invention by a method having the features according to claim 1, a corrugator having the features according to claim 14, and a computer program product having the features according to claim 15. Advantageous embodiments, further developments, and variants are the subject of the dependent claims. The statements made in connection with the method also apply, mutatis mutandis, to the corrugator and to the computer program product, and vice versa. If steps of the method are specified below, advantageous embodiments of the corrugator result from the fact that the corrugator is designed to carry out one or more of these steps (in particular by means of a control unit of the corrugator). Analogously, advantageous embodiments for the computer program product result in that it comprises commands which, when executed by a corrugator, cause it to carry out one or more of these steps.

The method is used to produce a corrugated cardboard web by means of a corrugator. First of all, a plurality of paper rolls are prepared, each comprising a paper web made of paper. The paper rolls are provided in particular in a roll storage facility, from which the paper rolls are fed to the corrugator as required and which may be restocked by delivery of new paper rolls. The roll storage facility is usually located in close proximity to the corrugator.

The paper rolls are each characterized by a number of paper parameters, which have individual values for each of the paper rolls, and therefore each of the paper rolls is individually characterized on the basis of its values for the paper parameters. Here and in general, “a number of” is understood to mean “one or more” or “at least one”. The paper parameters and their values for an individual paper roll are also referred to as “paper data” and collectively form a data record for that paper roll.

A core idea of the invention is in particular that, of these plurality of paper rolls (which are available for the production of the corrugated cardboard web), precisely those which, on the basis of their paper parameters, lead to the best possible production result, i.e. to a corrugated cardboard web with the highest possible quality, are combined with one another during the production of a corrugated cardboard web. This procedure is also referred to as “role matching” or “role pairing” for short. In this respect, the method described here is also a method for selecting paper rolls for the production of a corrugated cardboard web. The paper rolls are therefore not combined at random, but are intelligently selected and combined on the basis of the paper parameters. The selection, and preferably the entire method, is in particular automated. Using the paper data, the various paper rolls are cleverly combined such that the overall production of the corrugated cardboard web is optimized. This provides intelligent “role matching”, in which two paper rolls are combined with one another, taking both their paper data into account. Instead of randomly feeding paper rolls, the paper roll fed at a given time is selected based on how well it matches the other paper rolls that have just been fed in or have already been processed.

In the present case, an assignment rule is provided which links the paper parameters of two (i.e. at least two) paper rolls with a quality parameter which results for the production of the corrugated cardboard web when these two paper rolls are combined. The quality parameter therefore indicates how good a match two paper rolls are and is, in particular, directly or indirectly also a measure of the quality of the corrugated cardboard web that can be achieved by combining these paper rolls. The assignment rule is thus used to evaluate a specific combination of two paper rolls and thus enables the selection process to be optimized. For the sake of simplicity and without loss of generality, it will be assumed below that only two paper rolls are combined with one another, but the statements also apply analogously to combinations of more than two paper rolls. The assignment rule therefore assigns a quality parameter, or more precisely: a value for the quality parameter, to a corresponding combination of paper parameters, or more precisely: their values. The quality parameter regularly, but not necessarily, varies for different combinations of paper rolls. The details of the assignment rule are of secondary importance for the time being; the only thing that is initially important is the fact that the assignment rule links a specific combination of paper rolls with a quality parameter on the basis of the paper parameters of said paper rolls. This is done, for example, using a suitable calculation model and/or on the basis of historical data.

In a suitable embodiment, the assignment rule is learned, i.e. is generated in advance in a learning process, in particular a machine learning process, in which the quality parameter is measured as a function of the paper parameters. The assignment rule is then derived from this function. Various approaches are suitable for the learning process, but the details are not important here. Knowledge of the cause-effect relationships or causalities is not absolutely necessary; it is generally sufficient to empirically determine the assignment rule in advance through appropriate experiments, training procedures and/or a big data approach. In this respect, the assignment rule itself is not necessarily known either, but rather in particular a kind of black box which only outputs corresponding values for the quality parameter for given paper data (or for paper data of a first paper roll in combination with a quality parameter, then the paper data of an optimal second paper roll). For example, the assignment rule is implemented by a neural network or the like, e.g., in a virtual sensor of the corrugator. In principle, different solutions are conceivable and suitable, which achieve similar or identical results in different ways.

As part of the method, a first paper roll and a second paper roll are selected from the paper rolls using the assignment rule such that the quality parameter is optimized. The combination of the first and second paper roll is also referred to as a “roll pair” (or, if there are more than two rolls, a “roll tuple”). How exactly the quality parameter is optimized is initially of secondary importance and depends greatly on the specific quality parameter used. The term “optimized” is preferably understood to mean “minimized,” “maximized,” or “as close as possible to a target value”.

In principle, various approaches to selecting paper rolls are possible and are each also advantageous. In a first embodiment, the first paper roll is randomly selected or is predetermined in some other way, e.g. the first paper roll has already been received in the corrugator. In this case, the second paper roll is then selected, e.g. by determining the quality parameters for each combination of the first paper roll with the other available paper rolls using the assignment rule and then selecting the correspondingly optimal combination. Alternatively, the entire roll pair, i.e. also the first paper roll, is selected using the optimization, i.e. the best roll pair from all the available paper rolls. For example, the assignment rule is used to determine the quality parameters for all possible roll pairs and then the roll pair with the highest quality parameter is used.

In order to be able to reasonably select said rolls, at least two paper rolls are suitably provided as possible second paper rolls.

In the present case, it is assumed, without loss of generality, that the paper parameters of actually existing paper rolls are fed into the assignment rule in order to then determine the optimization parameter. This is also referred to as the “best available result” approach. An equivalent variant is to use the assignment rule to determine optimal paper data for the second paper roll from the paper data for the first paper roll and a given optimization parameter and then to select the paper roll from the available paper rolls whose paper data is closest to the optimal paper data as the second paper roll. This is also referred to as the “best available match” approach. In both cases the optimization parameter is optimized.

The method lastly involves producing the corrugated cardboard web by feeding the first and second paper rolls to the corrugator, which then joins the paper webs of this first and second paper roll together. In other words: the two paper rolls are fed into the corrugator and the corrugated cardboard web is then produced from the paper webs thereof, optionally in combination with further paper webs from other paper rolls. The paper webs of the first and second paper rolls are therefore either directly joined to one another or indirectly joined via one or more further paper webs. The first and second paper rolls are fed to the corrugator either simultaneously or one after the other. It should be emphasized that the paper webs of the first and the second paper rolls are also joined to one another, since only in this case do the two paper webs interact in such a way that consideration of their paper parameters is relevant and advantageous.

In particular, several paper rolls are fed into the corrugator in two ways. On the one hand, several paper rolls are fed to the corrugated cardboard web, the paper webs of which are connected to each other as different layers of the corrugated cardboard web, i.e., several paper rolls for different layers are fed more or less simultaneously. On the other hand, a plurality of paper rolls are fed to the corrugated cardboard web one after the other in order to provide continuous operation. For the method described here, the paper webs of the first and second paper rolls preferably form different layers (e.g. fluting, front/back liners, etc.) of the corrugated cardboard web. This will also be assumed below without any restriction of generality. However, the invention described herein is in principle also advantageous if two paper webs form the same layer. This regularly occurs during splicing, i.e. when the first paper roll is almost used up and the second paper roll is then spliced to the end of the first paper roll in order to ensure that the corrugator operates continuously. This creates a splice point at which the two paper rolls are joined to one another and which may benefit from the optimization described here.

The corrugator has a number of adjustable operating parameters, by means of which the behavior of one or more processing units of the corrugator is controlled using open-loop control. Examples of the processing units are unwinder, splicer, printer, single facer, bridge, preheater, gluing unit, double facer, drying section, cutting unit, slitting unit, grooving unit, and the like. However, the details of the processing units are not important in this case. Examples of operating parameters are: conveyor speed, tension, ink quantity, corrugating roller temperature, glue quantity, water quantity for moistening, drying temperature, cutting and/or grooving position, and the like. The details of the processing parameters are not important here either.

A respective paper roll is formed in particular by a paper web and a sleeve (also referred to as a bushing), on which the paper web is rolled up, which is unwound by the corrugator for producing the corrugated cardboard web by means of an unwinder and is suitably connected to further paper webs of other paper rolls. A particular paper web is made of paper or consists of paper.

As already described, the paper rolls are each characterized by a number of paper parameters. More specifically, the paper of a specific paper roll is characterized by these paper parameters. The paper parameters thus specifically characterize the paper of a specific paper roll; however, for the sake of simplicity, reference will occasionally also only be made to the paper roll in this case, with the paper thereof in particular being meant. The paper parameters each describe, directly or indirectly, one or more properties of the paper on the paper roll, so that different values mean or imply different properties. The term “paper parameters” is particularly broadly defined and does not mean only physical, mechanical, chemical properties of the paper itself, but any information that enables the characterization of the paper, e.g., place of manufacture, time of manufacture, storage time of the paper, or operating parameters of a paper machine during the production of the paper and the like. In a suitable embodiment, the paper data are averaged values or spatially and/or temporally resolved values (e.g., spatially resolved moisture along the length and width of the paper web) or a combination thereof. For example, the paper parameter is a fiber orientation of the paper in the paper roll, and the corresponding value is a for a first paper roll, b for a second paper roll, and c for a third paper roll.

The value of the paper parameter is therefore individual for each paper roll (more precisely: its paper), but this does not exclude the possibility that two paper rolls do not have the same value for a certain paper parameter. As a rule, however, the papers of two paper rolls differ in terms of one or more of the paper parameters due to their production, storage, transport, etc., and therefore have different properties, thus affecting processing thereof in the corrugator. This individuality of the paper rolls is taken into account in the present case in the production of the corrugated cardboard web and is used to optimize the production of the corrugated cardboard web by cleverly combining the paper rolls. The paper data is not or not exclusively determined in the corrugator, but beforehand, and in particular away from and independently of the corrugator. The paper data advantageously contain the history and/or the previous life of the paper in the paper roll, so that the paper data represent, so to speak, a life story of the paper roll. In particular, the paper data do not necessarily contain only those paper parameters that could also be determined inline in the corrugator, but, advantageously, also those paper parameters that, in principle, cannot be determined within the corrugator, e.g., paper production process parameters. The method presented here is therefore dynamic, in that individual properties of the paper roll are taken into account. The paper parameters themselves—and thus the paper data as a whole—are static, i.e., constant for the paper of an entire paper roll, or dynamic, i.e., vary along the paper of the paper roll, so that, for example, a parameter curve results on the basis of the portion of the paper web that is currently being unwound. A combination is also possible, so that one or more paper parameters are static, and one or more other paper parameters are dynamic.

In general, there has thus far been no special coordination of the paper rolls fed in. This is also initially not necessary per se, because the corrugated cardboard layer in principle allows for closed-loop feedback control, which uses the corrugated cardboard web produced to respond by readjusting any errors and inaccuracies that arise from combining paper rolls with varying paper parameters. However, readjustment is not necessarily possible in every case. In addition, readjustment typically results in rejects or at least a non-optimal product being produced in the meantime, which reduces the economic efficiency of the corrugator. In contrast, the method presented here enables the optimal paper roll, i.e. the paper roll which leads to an optimal result and therefore has particularly little need for readjustment, to be selected in advance each time. Intelligently combining the paper rolls with one another accordingly takes the load off a closed-loop control system used for making readjustments.

Preferably, the values used for the paper parameters of a single paper roll are aggregated as far as possible, i.e., received by the corrugator from as few different sources as possible and preferably only from a single source, and thus as a data set that is summarized to the greatest possible extent. The paper data are therefore preferably not transferred to the corrugator at different locations and/or at different times, but collected in a single data set and/or at a single time. Optionally, the paper data of several paper rolls can even be aggregated in such a way that it is still possible to assign individual values to a single paper roll—expediently, by means of an ID for each paper roll.

The invention makes particular use of the fact that the properties of the paper of a specific paper roll are actually also individually taken into account in order to select a second paper roll that best matches a first paper roll having given properties and then to produce a corrugated cardboard web with maximum quality. Accordingly, a further advantage is that paper rolls with a larger degree of tolerance can also be used, since any deviations from values defined as being ideal for the paper parameters can now be optimally compensated for by clever combination with a correspondingly suitable second paper roll. This makes it easier and more cost-effective to produce paper and paper rolls in general. In addition, paper rolls that would previously have been discarded due to severe defects can now also be used.

Optimizing production is possible in various ways. Suitably, the production of the corrugated cardboard web is optimized with the aim of improving the properties of the corrugated cardboard web (corrugated cardboard properties) or with the aim of improving the operation and in particular the open-loop control of the corrugator. Accordingly, in a first suitable embodiment, the quality parameter is a corrugated cardboard parameter which describes a property of the corrugated cardboard web or is dependent on such a corrugated cardboard parameter (e.g. a combination of a plurality of corrugated cardboard parameters to form a single quality parameter is also advantageous). Suitable corrugated cardboard parameters are in particular the extent of bending of the corrugated cardboard web, also referred to as “warp”, a strength value of the corrugated cardboard web, in particular edge crush resistance (e.g. according to ECT=edge crush test), flat crush resistance (e.g. according to FCT=flat crush test) or the like and generally any corrugated cardboard property.

Alternatively or additionally, the quality parameter is a variation (e.g. closed-loop control range or interval) of an operating parameter of the corrugator during the production of the corrugated cardboard web or is dependent on such a variation (e.g. a combination of a plurality of variations to form a single quality parameter is also advantageous). This is based on the consideration that the corrugator has a certain amount of flexibility in terms of operating parameters and that the paper rolls are then conveniently selected and combined in such a way that only the smallest possible amount of flexibility is required. In other words, variation is minimized. The corrugator then requires very little readjustment during operation.

In an advantageous embodiment, the assignment rule is designed in such a way and the quality parameter is selected in such a way that they are optimized by a combination of such paper rolls whose paper parameters balance each other out. The type of balancing depends in particular on the paper parameters. The term “balance” is understood in particular to mean that the two values for a paper parameter for two paper rolls have the same absolute value but opposite signs, or that the distances between the values and a target value are equal, or that the difference between two values does not exceed a maximum difference. For a paper parameter that specifies an orientation or an angle, e.g. fiber orientation, “balance” is then understood to mean in particular that the orientations are perpendicular to one another.

In a preferred embodiment, one of the paper parameters of a paper roll is a moisture content (dynamic or static) and the quality parameter is a measure (difference) of a difference in moisture contents, i.e. the quality parameter indicates how much the moisture contents of two paper rolls processed at the same time differ. The quality parameter is, for example, simply just the difference or ratio between the moisture contents of two paper rolls. Alternatively, the quality parameter is a parameter dependent thereon, e.g. a so-called warp (curvature or bending) of the corrugated cardboard web produced from the paper rolls. The assignment rule links the moisture contents accordingly, e.g. subtracts them from one another. The quality parameter is then optimized by, for example, minimizing the difference if there is one or at least ensuring that it does not exceed a predetermined maximum value.

Advantageously, during or after the production of the corrugated card

board web, the quality parameter for a particular combination of two paper rolls is repeatedly measured and the paper parameters of these two paper rolls are stored together with the quality parameter as historical data in a database. The assignment rule is then appropriately based on the historical data. In this way, automated “role matching” based on experience is realized. Such use of historical data is also suitable for learning an assignment rule, as already described above. A simple comparison with the historical data is also useful, e.g. for a given first paper roll, the historical data is searched to find the paper roll that is most similar to the first paper roll in terms of paper parameters. In the historical data, a second paper roll having paper parameters which optimize the quality parameter is assigned thereto. Therefore, the remaining paper rolls are now searched to find the one that is most similar to this historical, second paper roll, and this is then selected.

Which paper parameters are actually used is initially of secondary importance and becomes less relevant as the number of paper parameters increases. Accordingly, preferably at least 10 paper parameters are used, in particular at least 100. The total volume of paper data results primarily from the number of values stored for the respective paper parameters. A static paper parameter contains only a single value (e.g., running meter on the paper roll, production date, or mean value of a dynamic paper parameter, average moisture content), whereas a dynamic paper parameter contains a plurality of values (e.g., moisture content as a function of the width and length of the paper roll), which is dependent in particular on the concentration of values/sampling rate (e.g., 1/cm) and is in particular regularly in the range of 1,000 to 1,000,000 or more. The paper parameters do not necessarily have to be in an immediately recognizable causal relationship with respect to the quality parameter either. Especially in the Big Data approach mentioned above, knowledge of relations is of secondary importance. However, some paper parameters regularly have a greater influence on the quality of the corrugated cardboard web than other paper parameters and are therefore preferably used, especially when only a few (i.e., at most 10) paper parameters or only one paper parameter is/are used. Therefore, in a suitable embodiment, one or more of the paper parameters are selected from the following paper parameters: fiber orientation of the paper of the paper roll, failure stress of the paper of the paper roll.

In a suitable embodiment, at least one of the paper parameters is a dynamic paper parameter, the values of which are specified as a function of the width and/or length of the paper web of the paper roll. By contrast, static paper parameters have the same value along the entire paper web. Suitable dynamic paper parameters are: fiber orientation as a function of a width and/or length of the paper web, temperature as a function of a width and/or length of the paper web, e.g., in the form of a “heat map,” which indicates the temperature at a particular point on the paper web, and moisture as a function of a width and/or length of the paper web, analogously, for example, in the form of a “moisture map”. A dynamic paper parameter is distinguished in that it has potentially different values at different points on the paper web and therefore describes an inhomogeneity of the paper roll. Using one or more dynamic paper parameters results in a more detailed picture of the paper roll, which is advantageously used to optimize the process of combining the paper rolls.

It is also expedient to use paper production process parameters, i.e., process parameters that themselves were used in the production of the paper of a particular paper roll, as the paper parameters. The paper production process parameters are not immediate, direct properties of the paper (such as moisture, fiber orientation, length, width, etc.), but parameters of the production of the paper, and thus only secondary or indirect paper parameters. In a suitable embodiment, the paper parameters accordingly comprise a number of paper production process parameters which were used in the production of the paper roll. The paper production process parameters are in particular operating parameters of a paper machine for producing the paper roll and/or for producing the paper of the paper roll. The paper production process parameters are expediently used to determine a correlative relationship between the production of the corrugated cardboard and the production of the paper used therefor, which relationship is sometimes not apparent in the direct paper parameters. A subsequent determination of other paper parameters such as failure stress and fiber orientation, temperature, moisture, and the like may therefore be unnecessary, such that, in an advantageous embodiment, these are completely or partially dispensed with. This is based upon the knowledge that ultimately the production of the paper roll significantly influences its properties, and that the production in turn is significantly influenced by the paper production process parameters. Therefore, they are advantageously directly used for the selection and combination of paper rolls.

Suitable paper parameters are listed below:
a) Paper roll properties
   (exact) sleeve outer diameter
   (exact) running meters on the paper roll
   splices in the paper roll
b) History of the paper
   production date
   manufacturer's name
   place of manufacture
   date of manufacture
   storage time
   storage conditions (e.g., moisture and/or ambient temperature)
   transport time
   transport conditions (e.g., moisture and/or ambient temperature)
c) Basic properties of the paper
   moisture/moisture content
   mass per unit area
   thickness
   ash content
   fiber orientation (also fiber orientation angle)
d) Tensile properties of the paper
   breaking strength
   tear length
   elongation at break
   modulus of elasticity
e) Surface/printability properties of the paper
   smoothness, e.g., according to Bekk
   roughness, e.g., according to Bendtsen
   air permeability, e.g., according to Bendtsen/Gurley
f) Corrugated cardboard properties (especially, corrugated cardboard base paper properties)
   flat crush resistance (e.g., according to CMT=Concora Medium Test, FCT=Flat Crush Test, or the like)
   strip crush resistance (e.g., according to SCT=Short-Crush-Test)

The above list indicates preferred paper parameters, but is not intended to be exhaustive. The use of only some (optionally only one) of the paper parameters mentioned is already advantageous.

Regardless of whether a paper parameter is static or dynamic, the most suitable paper parameters are those which change as little as possible or not at all during the life of the paper roll, i.e., until it is processed in the corrugator.

Suitably, the values of the paper parameters of a particular paper roll were already determined during its production, especially in the case of the paper production process parameters mentioned above. Alternatively or additionally, the values of the paper parameters of a respective paper roll were determined after its production and in particular by means of a laboratory test. In general, it is advantageous if at least some of the paper parameters are determined during or immediately after production and in particular by the manufacturer of the paper roll itself and stored appropriately, e.g., on a data carrier, in order to be transmitted later to a corrugator.

The corrugator expediently has a data interface via which the values of the paper parameters of the paper of a respective paper roll are transmitted to the corrugator. In accordance with the foresighted approach preferred here, all values are preferably transmitted collectively as a single, aggregated data record via the data interface and are then immediately available, i.e. the corrugator can access the paper data while the paper rolls are still stored in the roll storage facility, for example, or even earlier. The corrugator is suitably connected to the roll storage facility via the data interface.

In a particularly preferred embodiment, each paper roll is assigned a data carrier on which the individual values of the paper parameters of the paper of the respective paper roll are stored. Each data carrier is therefore assigned to exactly one paper roll and, in particular, contains only the paper data of a single paper roll. Preferably, the data carrier for the method described herein is read by the corrugator. For this purpose, the corrugator has a suitable reader. The reader is in particular a part of the data interface already mentioned. The data carrier is suitably a code, e.g., QR code or barcode, a transponder, e.g., RFID tag or NFC tag, or a volatile or non-volatile memory, e.g., a floppy disk, a CD, or a flash memory. The reader is correspondingly, for example, a scanner, a receiving unit with antenna, a drive, a USB port, or the like. The data carrier enables an offline solution in which the values of the paper parameters are transmitted to the corrugator without the corrugator having to be connected to the Internet or another network in order to receive the data set for a particular paper roll.

The data carrier is either attached to the paper roll or is provided separately from it. In one embodiment, the data carrier is a label or a type of data sheet for the paper roll and is also called a “roll tag”. The data carrier can also advantageously be shipped together with the paper roll. Accordingly, in an advantageous embodiment, the data carrier is attached to the paper roll, e.g., directly on its paper web or on a packaging of the paper roll, e.g., glued or printed directly on the paper or on the sleeve. This makes assigning and handling the data set particularly straightforward. For example, the data carrier is a code which is attached to the paper roll and which is read by a reader when it is delivered to the roll storage facility.

In principle, it is conceivable that a paper roll be used several times (e.g., three times), i.e., after being fed into the corrugator, it is not necessarily used up completely, but only partially, and is then removed from the corrugator and stored again. If necessary, the now partially used paper roll is then fed back into the corrugator at a later time point. The data carrier is therefore preferably designed in such a way that it is reliably linked to the paper roll even when the paper roll is fed into and removed from the corrugator several times. In a suitable embodiment, the data carrier is detachable and is removed when the paper roll is fed in, and re-attached to the paper roll when it is removed and subsequently stored. In another suitable embodiment, the data carrier is attached to the paper roll in such a way that the data carrier does not have to be removed, i.e., remains on the paper roll when it is processed in the corrugator. For this purpose, the data carrier is expediently mounted in the center, in particular on or in a sleeve of the paper roll. Contactless or electronically readable data carriers such as RFID and NFC tags and the like are particularly suitable for this purpose. Overall, this ensures that the paper parameters are available throughout the entire service life of a paper roll, even if it is used multiple times. For the ID already mentioned, which is described in greater detail below, the statements regarding the data carrier apply analogously.

Updating the paper parameters is particularly advantageous when paper rolls are used multiple times. For this purpose, in a suitable embodiment, one or more of the paper parameters of a paper roll are updated if this paper roll is only partially used and is removed from the corrugator and is temporarily stored for later reuse, in particular away from the corrugator, e.g., in a roll storage facility. The update is either a change to an existing paper parameter or an addition of a new paper parameter. It is useful, for example, to update the length of the paper, i.e., to store the remaining length of paper, or the diameter of the paper roll and basically all properties of the paper roll which change during processing in the corrugator. A suitable, newly added paper parameter, for example, is an unwinding direction, i.e., the direction in which the paper roll was unwound during processing (especially for paper from which a wave of the corrugated cardboard web is made). Particularly advantageous is an embodiment in which one or more operating parameters of the corrugated cardboard system which were used when processing the paper roll are stored when the paper parameters are updated, so that when the paper roll is used again, the operating parameters last used for it are immediately accessible and usable. Once selected, the operating parameters are inherited, so to speak. Alternatively or additionally, the update saves which other paper rolls the paper roll was processed with and, optionally, which operating parameters were used. In this way, operating parameters are advantageously learned which are particularly advantageous in interaction with such or similar (e.g., from the same batch) paper rolls. The update is carried out in particular with a writer of the corrugator. Optionally, the reader and the writer can be combined to form one writer and reader.

Alternatively or in addition to the aforementioned offline solution, an online solution is also generally advantageous, e.g., a cloud solution. Such an online solution has the particular advantage that the determination of paper parameters, e.g., by means of a laboratory test, is possible in parallel (i.e., at the same time) to the transport of the paper roll, and the paper parameters are then transmitted online. In a suitable embodiment thereof, at least some (one or more), in particular each, of the paper rolls has an ID, in particular an individual ID (also referred to as an identifier or identification mark), which is stored together with the paper data for the corresponding paper roll in a database (identical or separate to the database already mentioned above), e.g., a data lake. In a suitable embodiment, the database is part of a cloud. The ID is used to assign a specific paper roll to its paper data, which is then determined and/or stored independently of the paper roll. The paper parameters are suitably passed to the database and/or to the corrugator via the data interface. However, the data interface is then not necessarily connected to the roll storage facility, but rather to a suitable network therefor. The use of an ID to assign a paper roll to a data record from a set of several aggregated data records has already been outlined above. The database is designed in a suitable manner separately from the corrugator and is connected to it for data transmission, e.g., via the Internet or via another network. Another suitable embodiment is one in which the database is part of the corrugator. The database is connected either to a single corrugator or, alternatively, to several corrugators. The corrugator requests the paper data of a particular paper roll from the database using its ID. In principle, it is also advantageous that the assignment rule is also stored in the database and that when the corrugator requests a given ID of a first paper roll, the database then directly outputs the ID for the second paper roll that best matches it. The ID, on the other hand, is advantageously attached to the paper roll; the statements made regarding the above-mentioned data carrier analogously also apply, mutatis mutandis, to the ID.

A corrugator according to the invention has a control unit which is designed to carry out a method as described above. The control unit is particularly designed to carry out one or more of the described steps of the method. For this purpose, the control unit in particular comprises the aforementioned database and/or is connected thereto. The control unit expediently contains the assignment rule.

Suitably, the corrugator has an order planning system. The order planning system is used to plan the selection, combination and feed of paper rolls from the roll storage facility in advance. The order planning system in particular requests the paper data for a corresponding first paper roll, e.g., by means of a reader or by means of an ID, and passes these paper data on to the control unit, which then uses the assignment rule to determine the best second paper roll to be combined with the first paper roll.

A computer program product according to the invention comprises instructions which, when executed by a corrugator, in particular as described above, prompt it to select a second paper roll from the plurality of paper rolls (minus the first paper roll) in a method as described above regarding a first paper roll using the assignment rule such that the quality parameter is optimized. In particular, the assignment rule for assigning two paper rolls to one another is implemented by the computer program product. Suitably, the computer program product also comprises commands which, when executed by a corrugator, implement the stated order planning system for the corrugator.

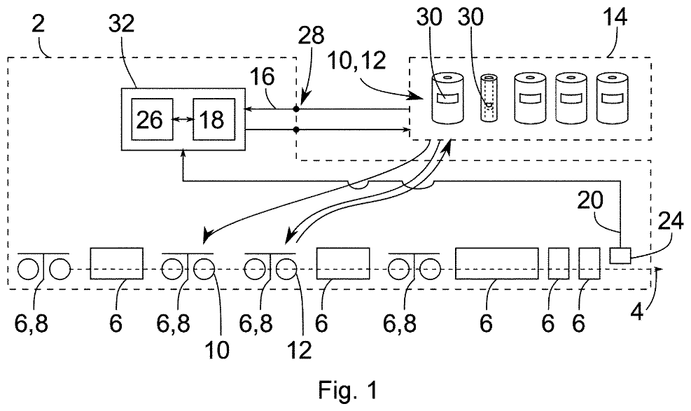

In the following, exemplary embodiments of the invention are explained in more detail with reference to a drawing. The only FIGURE in said drawings, FIG. 1, schematically shows a corrugator and a roll storage facility.

FIG. 1 shows a corrugator 2 for producing a corrugated cardboard web 4. The corrugator 2 comprises a number of adjustable operating parameters. Here and in general, “a number of” is understood to mean “one or more” or “at least one”. The operating parameters 6 are used to control the behavior of one or more processing units 6 of the corrugator 2 using open-loop control. Examples of the processing units 6 are unwinder 8, splicer, printer, single facer, bridge, preheater, gluing unit, double facer, drying section, cutting unit, slitting unit, grooving unit, and the like.

As part of a method for producing the corrugated cardboard web 4, a plurality of paper rolls 10, 12 are provided, each having a paper web made of paper. The paper rolls 10, 12 are provided in a roll storage facility 14, from which the paper rolls 10, 12 are fed to the corrugator 2 as required and which may be restocked by delivery of new paper rolls 10, 12. The roll storage 14 is usually located in close proximity to the corrugator 2.

The paper rolls 10, 12 are each characterized by a number of paper parameters 16 which have individual values for each of the paper rolls 10, 12 so that each of the paper rolls 10, 12 is individually characterized on the basis of its values for the paper parameters 16. The paper parameters 16 and their values for a single paper roll 10, 12 are also referred to as “paper data” and collectively form a data record for that paper roll 10, 12.

Furthermore, an assignment rule 18 is provided which links the paper parameters 16 of two (i.e. at least two) paper rolls 10, 12 with a quality parameter 20 which results for the production of the corrugated cardboard web 4 when these two paper rolls 10, 12 are combined. The quality parameter 20 therefore indicates how good a match two paper rolls 10, 12 are. For the sake of simplicity and without loss of generality, it will be assumed below that only two paper rolls 10, 12 are combined with one another, but the statements made also apply analogously to combinations of more than two paper rolls 10, 12. The quality parameter 20 regularly, but not necessarily, varies for different combinations of paper rolls 10, 12.

The assignment rule 18 is, for example, learned, i.e. is generated in advance in a learning process, in particular a machine learning process, in which the quality parameter 20 is measured as a function of the paper parameters 16. The assignment rule 18 is then derived from this function. The assignment rule 18 is not necessarily known per se, but is in particular a type of black box which only outputs corresponding values for the quality parameter 20 for given paper parameters 16 (or for paper parameters 16 of a first paper roll 10 in combination with a quality parameter 20 then the paper parameters 16 of an optimal second paper roll 12). For example, the assignment rule 18 is implemented by a neural network or the like.

By means of the assignment rule 18, a first paper roll 10 and a second paper roll 12 are selected from the paper rolls 10, 12 in such a way that the quality parameter 20 is optimized. The combination of the first and second paper rolls 10, 12 is also called a “roll pair”. In one possible embodiment, the first paper roll 10 is randomly selected or is predetermined in some other way, e.g. the first paper roll 10 has already been received in the corrugator 2. In this case, the second paper roll 12 is then selected, e.g. by determining the quality parameter 20 for each combination of the first paper roll 10 with the other available paper rolls 10, 12 in the roll storage facility 14 by means of the assignment rule 18 and then selecting the corresponding optimal combination. Alternatively, the entire roll pair, i.e. including the first paper roll 10, is selected using the optimization, i.e. the best roll pair from all the available paper rolls 10, 12. For example, the quality parameter 20 is determined for all possible roll pairs using the assignment rule 18 and the roll pair with the highest quality parameter 20 is then used.

In the present case, it is assumed, without loss of generality, that the paper parameters 16 of actually existing paper rolls 10, 12 are fed to the assignment rule 18 in order to then determine the optimization parameter 20. This is also referred to as the “best available result” approach. An equivalent variant is to use the assignment rule 18 to determine optimal paper parameters 16 for the second paper roll 12 from the paper parameters 16 for the first paper roll 10 and a predetermined optimization parameter 20 and then to select, as the second paper roll 12, the paper roll from the existing paper rolls 10, 12 whose paper parameters 16 are closest to the optimal paper data 16. This is also referred to as the “best available match” approach.

Finally, the corrugated cardboard web 4 is produced by feeding the first and second paper rolls 10, 12 to the corrugator 2, which then joins the paper webs of these first and second paper rolls 10, 12 together, optionally in conjunction with further paper webs of further paper rolls 10, 12. The first and the second paper roll 10, 12 are fed to the corrugator 2 either simultaneously or one after the other.

In the exemplary embodiment shown, the paper webs of the first and second paper rolls 10, 12 form different layers of the corrugated cardboard web 4. However, the statements made here apply, mutatis mutandis, if two paper webs form the same layer. This regularly occurs during splicing, i.e. when the first paper roll 10 is almost used up and the second paper roll 12 is then spliced to the end of the first paper roll 10 in order to ensure that the corrugator 2 operates continuously.

In the present case, each paper roll 10, 12 is formed by a paper web and a sleeve (also referred to as a bushing), on which the paper web is rolled up, which paper web is unwound by the corrugator 2 in order to produce the corrugated cardboard web 4 by means of an unwinder 8 and is suitably connected to further paper webs of other paper rolls 10, 12.

The value of the paper parameter 16 is individual for each paper roll 10, 12 (more precisely: its paper), but this does not exclude the possibility of two paper rolls 10, 12 also having the same value for a certain paper parameter 16. As a rule, however, the papers of two paper rolls 10, 12 differ with respect to one or more of the paper parameters 16 due to their production, storage, transport, etc., and therefore have different properties, thus affecting processing thereof in the corrugator 2. This individuality of the paper rolls 10, 12 is taken into account in the present case and used to optimize the production of the corrugated cardboard web 4 by skillfully combining the paper rolls 10, 12. The paper data contains, for example, the history and/or the previous life of the paper of the paper roll 10, 12 so that the paper data represent a life cycle of the paper roll 10, 12 so to speak. The paper parameters 16 themselves—and thus the paper data as a whole—are static, i.e., constant for the paper of an entire paper roll 10, 12, or dynamic, i.e., vary along the paper of the paper roll 10, 12, so that, for example, a parameter curve results on the basis of the portion of the paper web that is currently being unwound. A combination is also possible such that one or more paper parameters 16 are static, and one or more other paper parameters 16 are dynamic.

Optimizing production is possible in various ways. For example, the production of the corrugated cardboard web 4 is optimized with the aim of improving the properties of the corrugated cardboard web 4 (corrugated cardboard properties) or with the aim of improving operation and especially open-loop control of the corrugator 2. In the first case, the quality parameter 20 is, for example, a corrugated cardboard parameter which describes a property of the corrugated cardboard web 4, or depends on such a corrugated cardboard parameter. Suitable corrugated cardboard parameters are the extent of bending of the corrugated cardboard web 4, also referred to as “warp”, a strength value of the corrugated cardboard web 4, in particular edge crush resistance (e.g. according to ECT=edge crush test), flat crush resistance (e.g. according to FCT=flat crush test) or the like and generally any corrugated cardboard property. Alternatively or additionally, the quality parameter 20 is a variation (e.g. closed-loop control range or interval) of an operating parameter of the corrugator 2 during the production of the corrugated cardboard web 4 or is dependent on such a variation.

In one possible embodiment, the assignment rule 18 is designed in such a way and the quality parameter 20 is selected in such a way that they are optimized by a combination of such paper rolls 10, 12 whose paper parameters 16 balance each other out. The type of balancing depends in particular on the paper parameter 16.

In the exemplary embodiment in FIG. 1, during or after the production of the corrugated cardboard web 4, the quality parameter 20 for a corresponding combination of two paper rolls 10, 12 is repeatedly measured, here using a sensor 24, and the paper data of these two paper rolls 10, 12 are stored together with the quality parameter 20 as historical data in a database 26. The assignment rule 18 is then optionally based on the historical data. In this way, automated “role matching” based on experience is realized. Such use of historical data is also suitable for learning the assignment rule 18. A simple comparison with the historical data is also expedient, e.g. for a given first paper roll 10, the historical data is searched to find the paper roll 10, 12 which is most similar to the first paper roll 10 with regard to the paper parameters 16. In the historical data, this paper roll is assigned a second paper roll 12 with paper parameters 16 which optimize the quality parameter 20. Therefore, the remaining paper rolls 10, 12 are now searched to find the paper roll that is most similar to this historical second paper roll 12, and this is then selected.

Which paper parameters 16 are actually used is initially of secondary importance and also becomes less relevant as the number of paper parameters 16 increases. For example, at least 10 paper parameters 16 are used. The total volume of paper data results primarily from the number of values stored for the respective paper parameters 16. A static paper parameter 16 contains only a single value (e.g. running meters on the paper roll 10, 12, production date or mean value of a dynamic paper parameter 16, average moisture content), whereas a dynamic paper parameter 16 contains a plurality of values (e.g. moisture content as a function of the width and length of the paper roll 10, 12). In principle, however, it is also possible to use only a single paper parameter 16, e.g. the fiber orientation of the paper of the paper roll 10, 12 or the failure stress of the paper of the paper roll 10, 12.

In one possible embodiment, at least one of the paper parameters 16 is a dynamic paper parameter 16, the values of which are specified as a function of the width and/or length of the paper web of the paper roll 10, 12. By contrast, static paper parameters have the same value along the entire paper web. Paper production process parameters are also suitable as paper parameters 16, i.e. process parameters which themselves were used in the production of the paper for a corresponding paper roll 10, 12.

The corrugator 2 has a data interface 28, via which the values for the paper parameters 16 of the paper of a corresponding paper roll 10, 12 are transmitted to the corrugator 12. For example, all values are transmitted together as a single, aggregated data record via the data interface 18 and are then immediately available, i.e. the corrugator 2 can access the paper data while the paper rolls 10, 12 are still stored in the roll storage 14, for example, or even earlier. In the exemplary embodiment shown here, the corrugator 2 is connected to the roll storage facility 14 via the data interface 28.

In the present case, each paper roll 10, 12 is assigned a data carrier 30 on which the individual values for the paper parameters 16 of the corresponding paper roll 10, 12 are stored (offline solution). The data carrier 30 is read by the corrugator 2 for the method described herein. For this purpose, the corrugator 2 has a suitable reader, e.g. as part of the data interface 28. In the present case, the data carrier 30 is attached to the corresponding paper roll 10, 12 and is read by a reader, for example when it is delivered to the roll storage 14. Alternatively or in addition to the aforementioned offline solution, an online solution is also possible, e.g., a cloud solution. For this purpose, for example, each of the paper rolls 10, 12 has an individual ID (which is attached to the paper roll 10, 12 instead of the data carrier 30, for example), which is stored in the database 26 together with the paper data 16 of the corresponding paper roll 10, 12. The ID is used to assign a specific paper roll 10, 12 to its paper data 16, which is then determined and/or stored independently of the paper roll 10, 12. The paper parameters 16, for example, also reach the database 26 via the data interface 28, but the data interface 28 is then not necessarily connected to the roll storage facility 14, but rather to a suitable network. Alternatively, the database 26 is separate from the corrugator 2 and is connected thereto for transmitting data, e.g., via the Internet or via another network. In FIG. 1, the database 26 is part of the corrugator 2.

In principle, it is conceivable that a paper roll 10, 12 be used several times, i.e., after being fed into the corrugator 2, it is not necessarily fully used up, but is only partially used up and then removed from the corrugator 2 again and stored. This is indicated in FIG. 1 by an arrow from the corrugator 2 to the roll storage facility 14 and is also illustrated by the fact that a partially used-up paper roll 10, 12 that is therefore thinner than the other paper rolls 10, 12 is shown in the roll storage facility 14. If necessary, this now partially used-up paper roll 10, 12 is fed back to the corrugator 2 at a later time point. The data carrier 30 is therefore designed in such a way that it is reliably linked to the paper roll 10, 12 in this case, even when the paper roll 10, 12 is fed to and removed from the corrugator 2 several times. For example, the data carrier 30 is removable and is removed when the paper roll 10, 12 is fed in, and re-attached to the paper roll 10, 12 when it is removed and subsequently stored. In the partially used-up paper roll 10, 12 shown here, the data carrier 30 is attached in such a way that it does not have to be removed, i.e. it remains on the paper roll 10, 12 when this is processed in the corrugator 2. For this purpose, the data carrier 30 is attached in the center—in FIG. 1 to the sleeve of the paper roll 10, 12. The statements made regarding the data carrier 30 apply analogously to the above-mentioned ID.

The corrugator 2 also comprises a control unit 32 which is designed to carry out a method as described above. The control unit 32 is designed to carry out one or more of the described steps of the method and comprises the database 26 for this purpose. In addition, the control unit 32 in FIG. 1 also contains the assignment rule 18.

Individual aspects which are described or disclosed only in connection with the exemplary embodiment explicitly disclosed can in principle also be transferred to other exemplary embodiments, independently of the other concepts included in the exemplary embodiment.

### LIST OF REFERENCE SIGNS

2 corrugator
4 corrugated cardboard web
6 processing unit
8 unwinder
10 first paper roll
12 second paper roll
14 roll storage facility
16 paper parameter
18 assignment rule
20 quality parameter
24 sensor
26 database
28 data interface
30 data carrier
32 control unit

1. A method for producing a corrugated cardboard web by means of a corrugator,
wherein a plurality of paper rolls are provided, each comprising a paper web made of paper,
wherein the paper rolls are each characterized by a number of paper parameters which have individual values for each of the paper rolls such that each of the paper rolls is individually characterized on the basis of its values for the paper parameters,
wherein an assignment rule is provided which links the paper parameters of two paper rolls to a quality parameter which results for the production of the corrugated cardboard web when these two paper rolls are combined,
wherein a first paper roll and a second paper roll are selected from the paper rolls using the assignment rule such that the quality parameter is optimized,
wherein the assignment rule is designed in such a way and the quality parameter is selected so as to be optimized by a combination of the first paper roll and the second paper roll whose paper parameters balance one another out, and
wherein the corrugated cardboard web is produced by feeding the first paper roll and the second paper roll to the corrugator, which then joins the paper webs of the first paper roll and the second paper roll together.

2. The method according to claim 1,
wherein the quality parameter is a corrugated cardboard parameter, namely an extent of bending of the corrugated cardboard web (“warp”).

3. The method according to claim 1,
wherein the quality parameter is a variation of an operating parameter of the corrugator during the production of the corrugated cardboard web or is dependent on such a variation.

4. The method according to claim 1,
wherein the balance means that:
(i) the two values for a paper parameter for the first paper roll and the second paper roll have the same absolute value but opposite signs,
(ii) the distances between the values and a target value are equal, or
(iii) the difference between the two values does not exceed a maximum difference.

5. The method according to claim 1,
wherein one of the paper parameters of a corresponding paper roll is a moisture content and the quality parameter is a measure of a difference in moisture contents.

6. The method according to claim 1,
wherein during or after the production of the corrugated cardboard web, the quality parameter is repeatedly measured for a corresponding combination of two paper rolls and the paper parameters of these two paper rolls are stored together with the quality parameter as historical data in a database,
wherein the assignment rule is based on the historical data.

7. The method according to claim 1,
wherein the paper webs of the first and the second paper roll form different layers of the corrugated cardboard web.

8. The method according to claim 1,
wherein each paper roll has at least 10 paper parameters.

9. The method according to claim 1,
wherein one or more of the paper parameters is/are selected from the following paper parameters: fiber orientation of the paper of the paper roll, failure stress of the paper of the paper roll.

10. The method according to claim 1,
wherein at least one of the paper parameters is a dynamic paper parameter, the values of which are specified as a function of the width and/or length of the paper web of the paper roll.

11. The method according to claim 1,
wherein the paper parameters comprise a number of paper production process parameters used in the production of the paper of the corresponding paper roll.

12. The method according to claim 1,
wherein the values for the paper parameters of the paper of a specific paper roll are determined before this paper roll is fed to the corrugator.

13. The method according to claim 1,
wherein at least some of the paper rolls have an ID which is stored in a database together with the values for the paper parameters of the specific paper roll,
wherein the corrugator requests the values for the paper parameters of a specific paper roll from the database using its ID.

14. A corrugator which has a control unit designed to carry out a method according to claim 1.

15. A computer program product, comprising instructions which, when executed by a corrugator, prompt said corrugator to use the assignment rule to select a second paper roll from the plurality of paper rolls in a method according to claim 1 relating to a first paper roll such that the quality parameter is optimized.
